(19) United States
(12) Patent Application Publication
(10) Pub. No.: US 2002/0044780 A1
(43) Pub. Date: Apr. 18, 2002

(54) Optical-path apparatus of two-lens and multi-reflection

(76) Inventor: Huang Chih-Wen, Hsinchu (TW)

Correspondence Address: Raymond Sun, 12420 Woodhall Way, Tustin, CA, 92782, US

(21) Appl. No.: 09/827,060

(22) Filed: Apr. 5, 2001

(30) Foreign Application Priority Data
Oct. 17, 2000 (TW) 85211695A01

(51) Int. Cl. G03B 1/00

(52) U.S. Cl. 396/661

(57) ABSTRACT

An optical-path apparatus of two-lens and multi-reflection consists of a light source element, a reflection element, a camera lens and a charge coupling device element. The light source element supplies the “light” during scanning. The reflection element includes a first reflection mirror and a second reflection mirror. An appropriate management between the corresponding angles of two mirrors makes that the optic-path of “light” can be reflected twice or more between them. The first characteristic of this invention is a transparent first transparent window which is formed on the second mirror and is positioned between the original paper and the light source element. The second characteristic is a reflection area for reflecting the “light”; i.e. from the original paper, the reflected “light” passes through the first transparent window, and projects to the second lens and reflects back onto the reflection area on the first lens.

### BACKGROUND OF THE INVENTION

1. Field of the Invention

This invention relates to an optical-path apparatus of two-lens and multi-reflection, more particularly is for the optical-path apparatus of two-lens and multi-reflection with the combination of penetration area and reflection lens.

2. Description of the Prior Art

Please refer to FIG. 2, which is the prior art of “an optical-path apparatus of two-lens and multi-reflection”. It consists of a light source element 1, a dust-proof transparent lens 7, several paper-feeding rollers 5, a first reflection mirror 21, a second reflection mirror 22, a camera lens 3 and a charge coupling device element 4. The light source element 1 supplies the “light” during scanning. There is corresponding reflection area 221 on two reflection mirrors 21, 22. The dust-proof transparent lens 7 lies on a scanned paper 6. The “light” supplied by light source element 1 can penetrate the dust-proof transparent lens 7 onto the surface of original paper 6. From the original paper 6, the reflected “light” can penetrate dust-proof transparent lens 7 and projecting onto the first lens 21. The “light” processes twice or more reflections between two lens 21, 22. At last, the camera lens 3 focuses the “light” into image on the charge coupling device element 4.

Because the dust-proof transparent lens 7 and the second reflection mirror 22 are two separated and independent elements, there is the room for improvement in consideration of space allocation and cost saving as well.

### SUMMARY OF THE INVENTION

The main object of this invention is to provide an optical-path apparatus of two-lens and multi-reflection. The design feature is to coat part of a lens with a layer of material such that it keeps the ability to reflect the “light”. In the other hand, the another part of the lens maintains the state of transparency, so it keeps the function of dust-proof transparent lens in prior art. By doing so, the manufacturing process is simplified, the number of lenses is reduced and the cost is down.

The present invention of the optical-path apparatus of two-lens and multi-reflection includes a light source element, a reflective element, a camera lens and a charge coupling device element. The light source element supplies the “light” during scanning. The reflection element includes a first reflection mirror and a second reflection mirror. In the optical-path of the “light”, by arranging an appropriate relative angle between two mirrors can produce twice or more reflections between the first lens and the second lens. The characteristic is that there are two areas in the second lens. The first area is a transparent window which is positioned between the original paper and light source element. The second area is a reflection surface capable of reflecting the “light”. The reflected “light” from the original paper penetrates the transparent window, then projects to the another lens and reflects back to the reflection area of the first lens. After twice or more reflections between two lenses, the camera lens focuses the “light” into a image on the charge coupling device element.

In order to describe more for the operation principle of the invention, a detailed description together with drawings are presented as following.

### BRIEF DESCRIPTION OF THE DRAWINGS

FIG. 1 is the illustration of the optical-path apparatus of two-lens and multi-reflection.

FIG. 2 is the illustration of the prior art of the optical-path apparatus of two-lens and multi-reflection.

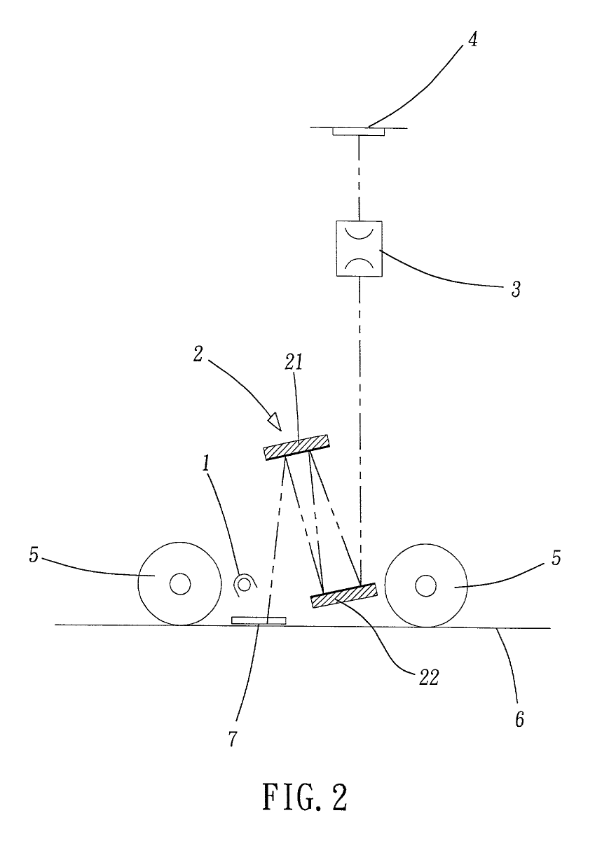

### DETAILED DESCRIPTION OF THE PREFERRED EMBODIMENT

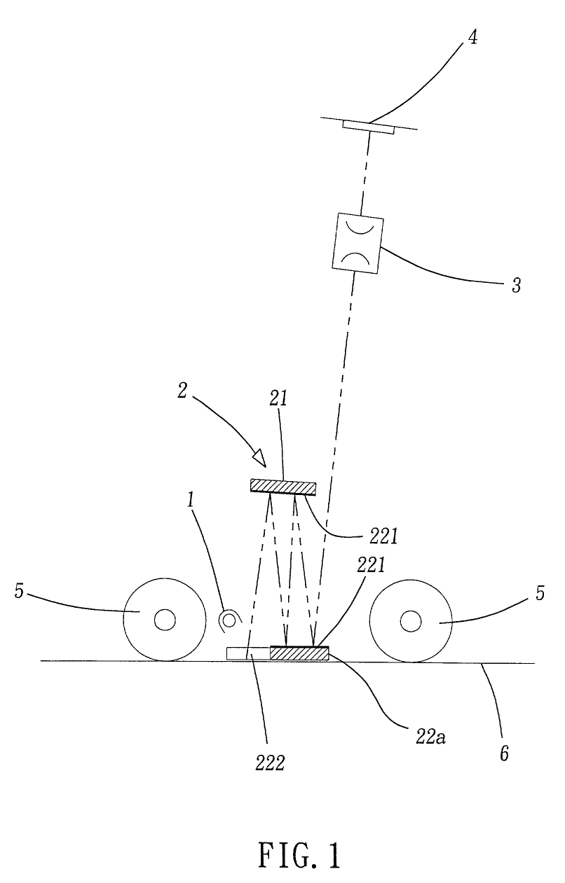

Please refer to FIG. 1. It illustrates the present invention of the optical-path apparatus of two-lens and multi-reflection. Its components include a light source element 1, a reflection element 2, a camera lens 3 and a charge coupling device element 4.

The light source element 1 supplies the “light” during scanning. The reflection element 2 includes a first reflection mirror 21 and a second reflection mirror 22. On reflection mirror 21, there is a reflection area 221 to reflect the light source. On reflective mirror 22, there are also a reflective area 221 to reflect light source and a transparent window 222 which is positioned between original paper 6 and light source element 1. Arranging an appropriated corresponding angle between the first reflection mirror 21 and the second reflection mirror 22 can make the “light” reflect back and forth twice or more times between two mirrors. Furthermore, the reflection area 221 and penetration area 222 are formed to one body on the second mirror 22. The reflection area 221 can be made by coating a layer of material with the ability to reflect the “light”. Another part of the mirror 22 can be kept in the state of transparency, so this kind of design will make the manufacturing process more simple, reduction of the lens number, and cost down.

For better effect, the material coated on the mirror to reflect the “light” can be mercury, silver or other reflective materials. These materials can be coated on the surface or bottom layer of the mirror and with the characteristic of reflection.

Furthermore, this invention should include several paper-feeding roller 5, which can be operated by manual or automation to move the original paper 6 relatively.

In the preferred embodiment of this invention of FIG. 1, the light source element 1 supplies the “light” during scanning. The “light” passes through the transparent window 222 of the second mirror 22 and projects onto the surface of original paper 6. Then, the reflected “light” from the original paper 6 again passes through the transparent window 222 and projects to the first reflection mirror 21. After two or more times reflection between reflection area 221 of the second mirror 22 and the first reflection mirror 21, the camera lens 3 focuses the “light” into an image on the charge coupling device element 4.

In summary, this invention provides a single mirror (as the second mirror 22), on which one part is coated with a layer of reflective material and another part maintains the originally transparent state. This mirror possesses both functions of “reflection mirror” and “dust-proof transparent mirror” in prior art. This design reduces the number of lens and simplifies structure, so the cost is down, therefore the volume is shrunk and the parts for installation are easier and simpler.

It may thus be seen that the object of the present invention set forth herein, as well as those made apparent from the foregoing description, are efficiently attained. While the preferred embodiment of the invention has been set forth for purpose of discourse, modifications of the disclosed embodiment of the invention as well as other embodiment thereof may occur to those skilled in the art. Accordingly, the appended claims are intended to cover all embodiments which do not depart from the spirit and scope of the invention.

What is claimed is:

1. An optical-path apparatus of two-lens and multi-reflection constituted mainly in the optical scanner, comprising;
a light source element which supplies the necessary “light” shining onto an intended, scanned paper;
a camera lens which will focuses the “light”;
a charge coupling device element which will transfer the signal of “light” into the digital signal which can be memorized and managed by the computer.
a reflective element which includes a first lens and a second lens. The relative angle of corresponding two mirrors is arranged so that the “light” coming from the original paper can be reflected in appropriate direction. In the mean time, in the course of the optical-path of the “light”, it makes two or more times reflection between the first mirror and the second mirror. At last, the camera lens focuses the “light” into an image onto the element of the charge coupling device element;
the main point is that there are two areas on the second mirror. A transparent window positioned between the original paper and the light source element. Another characteristic is a reflection area which can reflect the “light”. The reflective “light” first passes through the penetration area in the second mirror to the first mirror and then reflects back to the reflection area of the second mirror.

2. An optical-path apparatus of two-lens and multi-reflection cited in claim 1, wherein includes at least a paper-feeding roller and at least an original paper. The paper-feeding roller can be operated by manual or moved automatically with respect to the original paper.

3. An optical-path apparatus of two-lens and multi-reflection cited in claim 1, wherein the second reflection mirror consists of two parts. The first part is reflection area which is coated with a layer of material capable of reflecting the “light”. The other part of the second reflection mirror is a transparent window which stays at the original state of transparency.

4. An optical-path apparatus of two-lens and multi-reflection cited in claim 3, wherein one of the coated materials is mercury.

5. An optical-path apparatus of two-lens and multi-reflection cited in claim 3, wherein the material is coated on the surface of mirror to possess the characteristic of reflection.

6. An optical-path apparatus of two-lens and multi-reflection cited in claim 3, wherein the material is coated on the bottom of mirror to possess the characteristic of reflection.
